(19) United States
(12) Patent Application Publication
(10) Pub. No.: US 2024/0307269 A1
(43) Pub. Date: Sep. 19, 2024

(54) PORTABLE MULTIFUNCTIONAL HEATING FEEDING BOTTLE

(71) Applicant: Ying Hong, Wuxi (CN)

(72) Inventor: Ying Hong, Wuxi (CN)

(21) Appl. No.: 18/675,071

(22) Filed: May 27, 2024

(30) Foreign Application Priority Data
Apr. 2, 2024 (CN) 202420670498.1

(51) Int. Cl. A61J 9/00; A61J 11/00

(52) U.S. Cl. CPC A61J 9/00; A61J 11/008; A61J 2200/42

(57) ABSTRACT

The present disclosure relates to a portable multifunctional heating feeding bottle. The portable multifunctional heating feeding bottle solves the problems in the prior art that the feeding bottle has low heating efficiency and is inconvenient to carry. The present disclosure has the advantages that the portable multifunctional heating feeding bottle is conveniently and quickly disassembled and convenient to carry, has high heating efficiency, can achieve continuous heating and thermal insulation during drinking, and has a good use effect.

### TECHNICAL FIELD

The present disclosure relates to the technical field of feeding bottles, and in particular to a portable multifunctional heating feeding bottle.

### BACKGROUND

With the improvement of the living standard, people have an increasingly high requirement for functions of products for babies and infants. An existing feeding bottle has a relatively single function and generally does not have a thermal insulation function. In this way, milk may gradually become cold in a process that an infant drinks milk. Drinking milk at a low temperature may cause gastrointestinal discomfort to an infant. Moreover, the existing feeding bottle generally does not have a disinfection function, so that it needs to be disinfected by boiling. This is a cumbersome operation. In addition, the existing feeding bottle has low heating efficiency, and it is difficult for the existing feeding bottle to achieve continuous thermal insulation or heating in the process that an infant drinks milk. Moreover, a heating feeding bottle is inconvenient to carry.

To address the shortcomings in the prior art, people have conducted long-term exploration and proposed various solutions. For example, Chinese patent literature discloses an air bottle [CN201911094303.3], which includes a bottle body, a transparent part, a bottle teat, a base, a temperature measurement part, a heating part, and a disinfection lamp. The transparent part is connected to the bottle body and forms an accommodating chamber for accommodating milk; the bottle teat is connected to the bottle body; the base is connected to the bottle body and forms a storage chamber; the temperature measurement part is located in the storage chamber and is configured to measure a temperature of the bottle body or the transparent part; the heating part is located in the storage chamber and is configured to heat the bottle body or the transparent part, and the heating part is connected to the temperature measurement part; the disinfection lamp is located in the storage chamber and faces the transparent part; the disinfection lamp tilts in a direction from the base to the bottle teat and away from an axis of the bottle body; and there are a plurality of disinfection lamps which are spaced apart from each other around the axis of the bottle body. The temperature measurement part can detect a temperature of milk; the heating department can heat the milk; the disinfection lamp can disinfect the feeding bottle, so that the feeding bottle has a temperature detection function, a thermal insulation function, and a disinfection function.

The above solution to some extent solves the problem in the prior art that the feeding bottle does not have a disinfection function and milk may be gradually cold during drinking. However, this solution still has many shortcomings. For example: It is difficult for the feeding bottle to achieve continuous thermal insulation or heating in the process that an infant drinks milk, and a heating feeding bottle is inconvenient to carry.

### SUMMARY

The present disclosure aims to provide a portable multifunctional heating feeding bottle for the above problems.

To achieve the above objectives, the present disclosure adopts the following technical solutions: A portable multifunctional heating feeding bottle includes a feeding bottle main body; an upper end of the feeding bottle main body is connected with a bottle teat through a connecting assembly, and the bottle teat can be opened and closed through a bottle teat cover; a bottom of the feeding bottle main body is detachably connected with a heating base through a press type opening and closing mechanism; a bottom of the heating base is connected with a main unit seat; an electric control assembly is arranged between the main unit seat and the heating base; and heating sheets connected to the electric control assembly are arranged at the bottom and one side of the feeding bottle main body.

In the portable multifunctional heating feeding bottle above, the main unit seat is connected to the heating base by insertion, and an upper end surface of the heating base is provided with a positioning groove; one side of the positioning groove is provided with an upper cover body for connection that extends upwards; and a buckle connecting mechanism is arranged between the upper cover body for connection and one side of the feeding bottle main body.

In the portable multifunctional heating feeding bottle above, the buckle connecting mechanism includes an assembling groove arranged on an outer wall of the feeding bottle main body; an upper end of the assembling groove is provided with a positioning buckle, and an embedding part corresponding to the positioning buckle is arranged on an outer wall of a top end of the upper cover body for connection; and an inner wall of the upper cover body for connection is provided with a mounting slot for mounting the heating sheets.

In the portable multifunctional heating feeding bottle above, an annular insertion base is arranged at the bottom of the feeding bottle main body in a circumferential direction; the annular insertion base is inserted into the positioning groove; several locking insertion slots are arranged on a circumferential inner wall of the positioning groove; several elastic insertion locking parts corresponding to the locking insertion slots are arranged on a circumferential outer wall of the annular insertion base; and the heating sheets are fixedly arranged in the positioning groove and abut against the annular insertion base.

In the portable multifunctional heating feeding bottle above, the electric control assembly includes a control board; the control board is powered by a battery arranged at the bottom of the heating base; a display screen connected to the control board is arranged on a circumferential outer wall of the heating base; and a charging port connected to the battery is further arranged on the circumferential outer wall of the heating base.

In the portable multifunctional heating feeding bottle above, a bottom of the main unit seat is provided with a power supply port for allowing an interface of the control board to be plugged.

In the portable multifunctional heating feeding bottle above, the press type opening and closing mechanism includes a sliding fastener; one end of the sliding fastener is provided with an opening and closing button located on the outer wall of the heating base, and the other end is provided with an elastic member; the bottom of the heating base is provided with an elastic member movement limiting slot corresponding to the elastic member; the bottom of the heating base is provided with a travel limiting plate configured to limit a movement travel of the sliding fastener; and an end portion of the travel limiting plate resists against a limiting part at a bottom of the sliding fastener.

In the portable multifunctional heating feeding bottle above, an upper end of the sliding fastener is provided with a vertically arranged connecting fastener; the bottom of the feeding bottle main body is provided with a connecting slot for allowing the connecting fastener to be clamped; and a connecting hook that is mutually clamped with the connecting fastener to connect and locate the heating base is arranged in the connecting slot.

In the portable multifunctional heating feeding bottle above, the inner wall of the upper cover body for connection is provided with an insulation space; and after the upper cover body for connection is mounted in the positioning groove, an outer wall of the upper cover body for connection is kept being flush with a circumferential outer wall of the feeding bottle main body.

In the portable multifunctional heating feeding bottle above, the connecting assembly includes an annular connecting clamping slot arranged at the upper end of the feeding bottle main body; the annular connecting clamping slot is clamped with an annular clamping member; an inner wall of an upper end of the annular clamping member locates the bottle teat through a connecting buckle; an axial outer wall of the annular clamping member is provided with an annular clamping step configured to be connected to the bottle teat cover.

Compared with the prior art, the present disclosure has the advantages: The operation is convenient. The feeding bottle main body and the heating base are convenient to disassemble. Furthermore, the heating sheets are arranged at the bottom and side surface of the feeding bottle main body, so that this can effectively improve the heating efficiency, and the feeding bottle can achieve continuous heating to maintain the temperature in the process that an infant drinks milk. Meanwhile, the heating base and the main unit seat 5 can be removed simultaneously, so that the feeding bottle is convenient to carry and has a good use effect.

### BRIEF DESCRIPTION OF THE DRAWINGS

FIG. 1 is a schematic diagram of an entire structure of the present disclosure;

FIG. 2 is cross-sectional view of the present disclosure; and

FIG. 3 is an exploded view of the present disclosure.

In the drawings: feeding bottle main body 1, bottle teat 11, bottle teat cover 12, annular insertion base 13, elastic insertion locking part 131, connection slot 14, connection hook 15, connection assembly 2, annular connecting clamping slot 21, annular clamping member 22, connecting buckle 23, annular clamping step 24, heating base 3, positioning groove 31, locking insertion slot 311, upper cover body 32 for connection, insulation space 33, press type opening and closing mechanism 4, sliding fastener 41, opening and closing button 42, elastic member 43, elastic member movement limiting slot 44, travel limiting plate 45, limiting part 46, connecting fastener 47, main unit seat 5, power supply port 51, electric control assembly 6, control board 61, battery 62, display screen 63, charging port 64, heating sheet 7, buckle connecting mechanism 8, assembling groove 81, positioning buckle 82, embedding part 83, and mounting slot 84.

### DETAILED DESCRIPTION OF THE EMBODIMENTS

The present disclosure will be further explained in detail below in conjunction with the accompanying drawings and specific implementations.

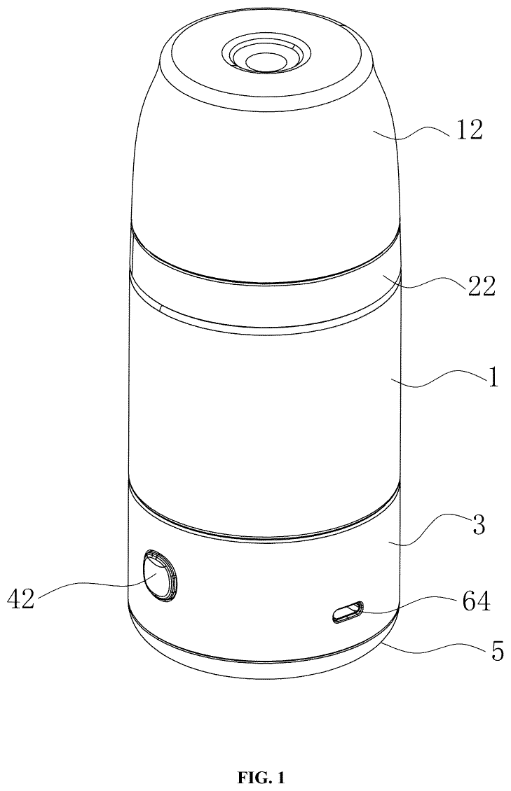

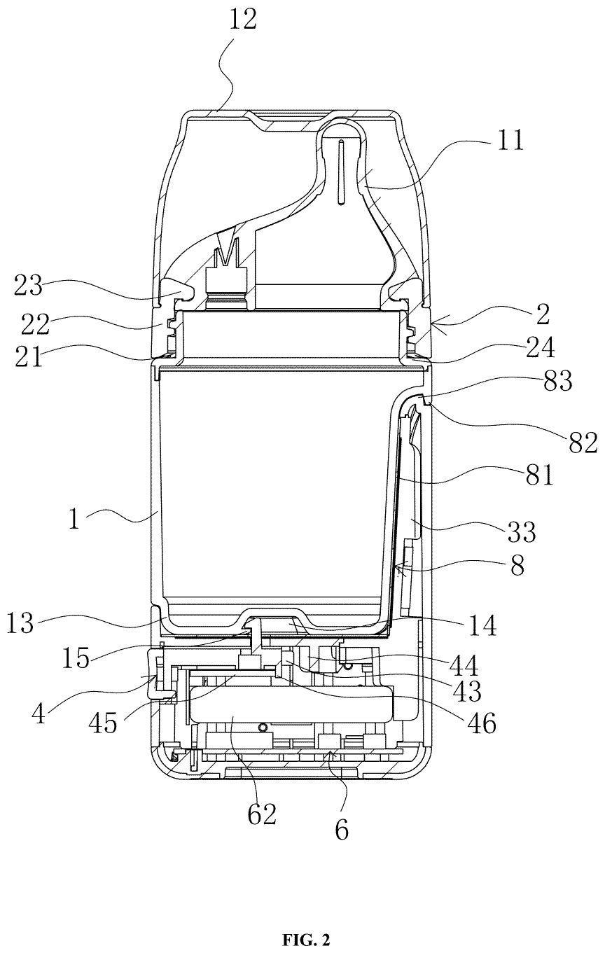

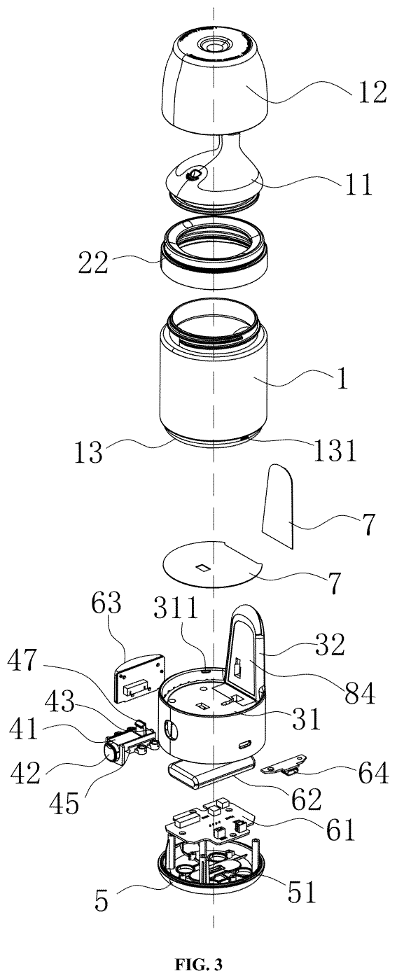

As shown in FIG. 1 to FIG. 3, a portable multifunctional heating feeding bottle includes a feeding bottle main body 1; an upper end of the feeding bottle main body 1 is connected with a bottle teat 11 through a connecting assembly 2, and the bottle teat 11 can be opened and closed through a bottle teat cover 12; a bottom of the feeding bottle main body 1 is detachably connected with a heating base 3 through a press type opening and closing mechanism 4; a bottom of the heating base 3 is connected with a main unit seat 5; an electric control assembly 6 is arranged between the main unit seat 5 and the heating base 3; and heating sheets 7 connected to the electric control assembly 6 are arranged at the bottom and one side of the feeding bottle main body 1.

The electric control assembly 6 controls the heating sheets 7 located at the bottom and the side surface to perform heating, thus improving the heating efficiency and achieving continuous heating in a drinking process to ensure the temperature of milk. After the press type opening and closing mechanism 4 is pressed, the heating base 3 and the main unit seat 5 can be removed simultaneously, so that the feeding bottle is convenient to carry.

The main unit seat 5 is connected to the heating base 3 by insertion, and an upper end surface of the heating base 3 is provided with a positioning groove 31; one side of the positioning groove 31 is provided with an upper cover body 32 for connection that extends upwards; and a buckle connecting mechanism 8 is arranged between the upper cover body 32 for connection and one side of the feeding bottle main body 1.

Detailedly, the buckle connecting mechanism 8 includes an assembling groove 81 arranged on an outer wall of the feeding bottle main body 1; an upper end of the assembling groove 81 is provided with a positioning buckle 82, and an embedding part 83 corresponding to the positioning buckle 82 is arranged on an outer wall of a top end of the upper cover body 32 for connection; and an inner wall of the upper cover body 32 for connection is provided with a mounting slot 84 for mounting the heating sheets 7.

The buckle connecting mechanism 8 enables the upper cover body 32 for connection to tightly abut against the outer wall of the feeding bottle main body 1, so that the heating sheets 7 abut against the feeding bottle main body 1. The inner wall of the upper cover body 32 for connection is provided with a threading slot.

Preferably, an annular insertion base 13 is arranged at the bottom of the feeding bottle main body 1 in a circumferential direction; the annular insertion base 13 is inserted into the positioning groove 31; several locking insertion slots 311 are arranged on a circumferential inner wall of the positioning groove 31; several elastic insertion locking parts 131 corresponding to the locking insertion slots 311 are arranged on a circumferential outer wall of the annular insertion base 13; and the heating sheets 7 are fixedly arranged in the positioning groove 31 and abut against the annular insertion base 13.

The feeding bottle main body 1 is inserted into the positioning groove 31 through the annular insertion base 13, and after rotation, the elastic insertion locking parts 131 are inserted into the locking insertion slots 311; and meanwhile, the elastic insertion locking parts 131 have arc-shaped outer walls, facilitating separation from the locking insertion slots 311 during removal.

Specifically, the electric control assembly 6 includes a control board 61; the control board 61 is powered by a battery 62 arranged at the bottom of the heating base 3; a display screen 63 connected to the control board 61 is arranged on a circumferential outer wall of the heating base 3; a charging port 64 connected to the battery 62 is further arranged on the circumferential outer wall of the heating base 3; and a bottom of the main unit seat 5 is provided with a power supply port 51 for allowing an interface of the control board 61 to be plugged.

A control and adjustment button is arranged on a lower side of the display screen 63.

More specifically, detailedly, the press type opening and closing mechanism 4 includes a sliding fastener 41; one end of the sliding fastener 41 is provided with an opening and closing button 42 located on the outer wall of the heating base 3, and the other end is provided with an elastic member 43; the bottom of the heating base 3 is provided with an elastic member movement limiting slot 44 corresponding to the elastic member 43; the bottom of the heating base 3 is provided with a travel limiting plate 45 configured to limit a movement travel of the sliding fastener 41; and an end portion of the travel limiting plate 45 resists against a limiting part 46 at a bottom of the sliding fastener 41.

Preferably, an upper end of the sliding fastener 41 is provided with a vertically arranged connecting fastener 47; the bottom of the feeding bottle main body 1 is provided with a connecting slot 14 for allowing the connecting fastener 47 to be clamped; and a connecting hook 15 that is mutually clamped with the connecting fastener 47 to connect and locate the heating base 3 is arranged in the connecting slot 14.

During removal, the opening and closing button 42 is pressed; the sliding fastener 41 slides to separate the connecting fastener 47 from the connecting hook 15; and the feeding bottle main body is pulled out. In the sliding process of the sliding fastener 41, the travel limiting plate 45 is used to perform rebound limitation and sliding supporting.

In addition, the inner wall of the upper cover body 32 for connection is provided with an insulation space 33; and after the upper cover body 32 for connection is mounted in the positioning groove 31, an outer wall of the upper cover body for connection is kept being flush with a circumferential outer wall of the feeding bottle main body 1.

This setting can ensure the entire gripping sensation and beautiful appearance of the feeding bottle main body 1.

Apparently, the connecting assembly 2 includes an annular connecting clamping slot 21 arranged at the upper end of the feeding bottle main body 1; the annular connecting clamping slot 21 is clamped with an annular clamping member 22; an inner wall of an upper end of the annular clamping member 22 locates the bottle teat 11 through a connecting buckle 23; an axial outer wall of the annular clamping member 22 is provided with an annular clamping step 24 configured to be connected to the bottle teat cover 12.

By the use of the annular clamping member 22, the stability of connection between the bottle teat cover 12 and the bottle teat 11 can be ensured.

In summary, the principle of this embodiment is as follows: During use, the electric control assembly 6 performs heating control. The heating sheets 7 are arranged on one side and the bottom of the feeding bottle main body 1 to simultaneously heat the bottom and the side surface. During drinking, the feeding bottle main body 1 tilts, namely, the heating sheet 7 on the side surface can be used to achieve continuous heating. During removal, the opening and closing button 42 is pressed to drive the sliding fastener 41 to slide, so that the connecting fastener 47 is separated from the connecting hook 15, and then the feeding bottle main body 1 can be pulled out. The feeding bottle is convenient to carry.

The specific embodiments described herein are only illustrative examples of the spirit of the present disclosure. A person skilled in the art to which the present disclosure belongs can make various modifications or supplements to the specific embodiments described or use similar manners to replace the specific embodiments, without deviating from the spirit of the present disclosure or going beyond the scope defined in the attached claims.

Although the terms, such as feeding bottle main body 1, bottle teat 11, bottle teat cover 12, annular insertion base 13, elastic insertion locking part 131, connection slot 14, connection hook 15, connection assembly 2, annular connecting clamping slot 21, annular clamping member 22, connecting buckle 23, annular clamping step 24, heating base 3, positioning groove 31, locking insertion slot 311, upper cover body 32 for connection, insulation space 33, press type opening and closing mechanism 4, sliding fastener 41, opening and closing button 42, elastic member 43, elastic member movement limiting slot 44, travel limiting plate 45, limiting part 46, connecting fastener 47, main unit seat 5, power supply port 51, electric control assembly 6, control board 61, battery 62, display screen 63, charging port 64, heating sheet 7, buckle connecting mechanism 8, assembling groove 81, positioning buckle 82, embedding part 83, and mounting slot 84, are used frequently, the possibility of using other terms is not excluded. The use of these terms is only for the convenience of describing and explaining the essence of the present disclosure. Interpreting them as any additional limitation is contrary to the spirit of the present disclosure.

What is claimed is:

1. A portable multifunctional heating feeding bottle, comprising a feeding bottle main body (1), wherein an upper end of the feeding bottle main body (1) is connected with a bottle teat (11) through a connecting assembly (2), and the bottle teat (11) is opened and closed through a bottle teat cover (12); a bottom of the feeding bottle main body (1) is detachably connected with a heating base (3) through a press type opening and closing mechanism (4); a bottom of the heating base (3) is connected with a main unit seat (5); an electric control assembly (6) is arranged between the main unit seat (5) and the heating base (3); and heating sheets (7) connected to the electric control assembly (6) are arranged at the bottom and one side of the feeding bottle main body (1).

2. The portable multifunctional heating feeding bottle according to claim 1, wherein the main unit seat (5) is connected to the heating base (3) by insertion, and an upper end surface of the heating base (3) is provided with a positioning groove (31); one side of the positioning groove (31) is provided with an upper cover body (32) for connection that extends upwards; and a buckle connecting mechanism (8) is arranged between the upper cover body (32) for connection and one side of the feeding bottle main body (1).

3. The portable multifunctional heating feeding bottle according to claim 2, wherein the buckle connecting mechanism (8) comprises an assembling groove (81) arranged on an outer wall of the feeding bottle main body (1); an upper end of the assembling groove (81) is provided with a positioning buckle (82), and an embedding part (83) corresponding to the positioning buckle (82) is arranged on an outer wall of a top end of the upper cover body (32) for connection; and an inner wall of the upper cover body (32) for connection is provided with a mounting slot (84) for mounting the heating sheets (7).

4. The portable multifunctional heating feeding bottle according to claim 3, wherein an annular insertion base (13) is arranged at the bottom of the feeding bottle main body (1) in a circumferential direction; the annular insertion base (13) is inserted into the positioning groove (31); several locking insertion slots (311) are arranged on a circumferential inner wall of the positioning groove (31); several elastic insertion locking parts (131) corresponding to the locking insertion slots (311) are arranged on a circumferential outer wall of the annular insertion base (13); and the heating sheets (7) are fixedly arranged in the positioning groove (31) and abut against the annular insertion base (13).

5. The portable multifunctional heating feeding bottle according to claim 1, wherein the electric control assembly (6) comprises a control board (61); the control board (61) is powered by a battery (62) arranged at the bottom of the heating base (3); a display screen (63) connected to the control board (61) is arranged on a circumferential outer wall of the heating base (3); and a charging port (64) connected to the battery (62) is further arranged on the circumferential outer wall of the heating base (3).

6. The portable multifunctional heating feeding bottle according to claim 5, wherein a bottom of the main unit seat (5) is provided with a power supply port (51) for allowing an interface of the control board (61) to be plugged.

7. The portable multifunctional heating feeding bottle according to claim 1, wherein the press type opening and closing mechanism (4) comprises a sliding fastener (41); one end of the sliding fastener (41) is provided with an opening and closing button (42) located on the outer wall of the heating base (3), and the other end is provided with an elastic member (43); the bottom of the heating base (3) is provided with an elastic member movement limiting slot (44) corresponding to the elastic member (43); the bottom of the heating base (3) is provided with a travel limiting plate (45) configured to limit a movement travel of the sliding fastener (41); and an end portion of the travel limiting plate (45) resists against a limiting part (46) at a bottom of the sliding fastener (41).

8. The portable multifunctional heating feeding bottle according to claim 7, wherein an upper end of the sliding fastener (41) is provided with a vertically arranged connecting fastener (47); the bottom of the feeding bottle main body (1) is provided with a connecting slot (14) for allowing the connecting fastener (47) to be clamped; and a connecting hook (15) that is mutually clamped with the connecting fastener (47) to connect and locate the heating base (3) is arranged in the connecting slot (14).

9. The portable multifunctional heating feeding bottle according to claim 3, wherein the inner wall of the upper cover body (32) for connection is provided with an insulation space (33); and after the upper cover body (32) for connection is mounted in the positioning groove (31), an outer wall of the upper cover body for connection is kept being flush with a circumferential outer wall of the feeding bottle main body (1).

10. The portable multifunctional heating feeding bottle according to claim 2, wherein the connecting assembly (2) comprises an annular connecting clamping slot (21) arranged at the upper end of the feeding bottle main body (1); the annular connecting clamping slot (21) is clamped with an annular clamping member (22); an inner wall of an upper end of the annular clamping member (22) locates the bottle teat (11) through a connecting buckle (23); an axial outer wall of the annular clamping member (22) is provided with an annular clamping step (24) configured to be connected to the bottle teat cover (12).
